(19) United States
(12) Patent Application Publication
(10) Pub. No.: US 2002/0185028 A1
(43) Pub. Date: Dec. 12, 2002

(54) Printing machine cylinder cleaning device

(75) Inventor: Herbert Stanka, Augsburg (DE)

Correspondence Address: OSTROLENK FABER GERB & SOFFEN, 1180 AVENUE OF THE AMERICAS, NEW YORK, NY, 100368403

(73) Assignee: Baldwin Germany GmbH

(21) Appl. No.: 10/165,830

(22) Filed: Jun. 7, 2002

(30) Foreign Application Priority Data
Jun. 7, 2001 (DE) 101 27 442.4

(51) Int. Cl. B41F 35/00; B41L 41/00

(52) U.S. Cl. 101/425

(57) ABSTRACT

A printing cylinder cleaning device of a sheet-fed printing machine. A control-cam/cam-follower is provided for transferring a cleaning unit over and above a gripping means from one outer surface portion of an impression cylinder to another outer surface portion of the latter. For the run of the cam follower onto the control cam, the throw-on pressure of the cleaning unit is reduced. Thereafter, it is increased again for the run onto the outer surface of the impression cylinder.

### BACKGROUND OF THE INVENTION

The invention relates to a printing machine cylinder cleaning device of a sheet-fed printing machine and to control over the movement of a cleaning device toward and away from the cylinder.

The invention is intended to achieve the object of reducing the noises and the material wear of the control-cam/cam-follower arrangement, even when the printing machine cylinder rotates at higher rotational speeds than the currently conventional rotational speeds of approximately 1200 revolutions per minute.

This object is achieved according to the invention.

Printing machine cylinders to be cleaned in sheet-fed printing machines are, in particular, the impression cylinder, often also designated simply as the printing cylinder. However, other printing machine cylinders of sheet-fed printing machines, which have gripper means for printed sheets, may also be cleaned.

A cleaning unit may clean the outer surface of a printing machine cylinder by dry-cleaning or preferably wet-cleaning. A cleaning unit having a moistenable washing cloth is known, for example, from DE 30 05 469 C2.

### SUMMARY OF THE INVENTION

A gripper for each sheet is disposed in a groove in the surface of the cylinder. A cam associated with each groove drives a respective cam follower to move the cleaning unit over the groove and over the gripper where it grips the sheet preventing the cleaning unit from entering the groove or contacting the gripper, at least in a manner which avoids damage to the cleaning unit. A pneumatic cylinder also operates the cleaning unit toward and away from the cylinder at the appropriate time. A control unit acts based upon the rotary position of the groove and gripper to appropriately move the cleaning unit with reference to the cylinder.

### BRIEF DESCRIPTION OF THE DRAWINGS

The invention is described below, with reference to the accompanying drawing, in terms of a preferred exemplary embodiment, in which

FIG. 1 diagrammatically shows a side view of a printing machine cylinder cleaning device according to the invention for a sheet-fed printing machine.

### DESCRIPTION OF THE PREFERRED EMBODIMENTS

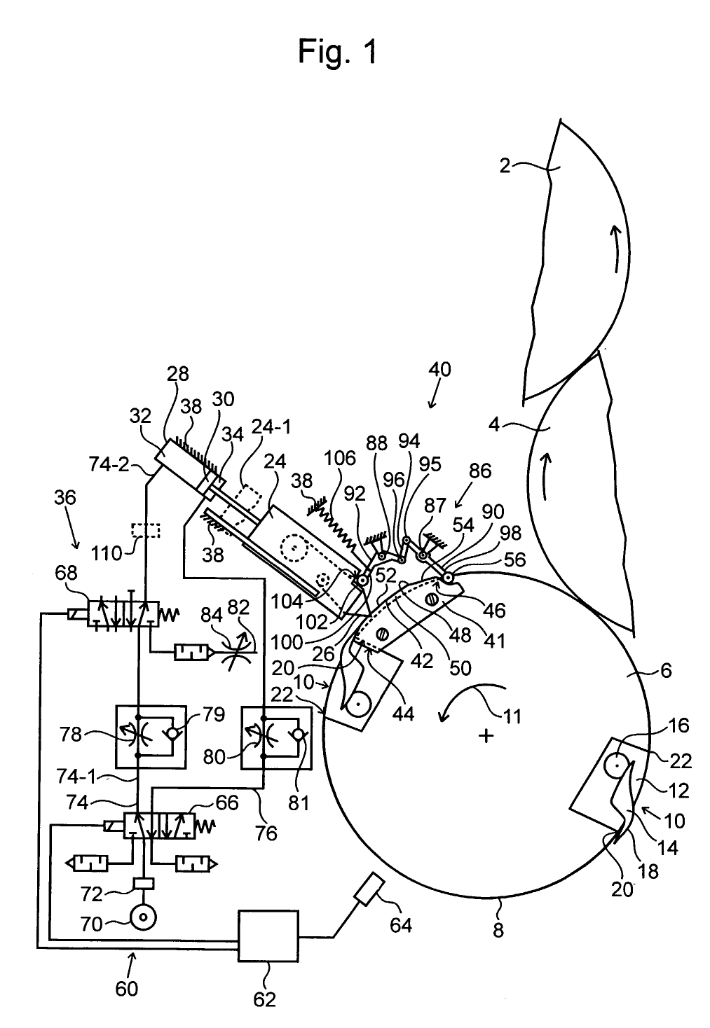

A sheet-fed printing machine is illustrated, partially truncated. It contains, for example, a plate cylinder 2, from which a printing image is transferred onto a rubber-blanket cylinder 4 which transfers the printing image onto a printed sheet (not illustrated) made of paper or of another material which is located on the outer surface 8 of an impression cylinder 6. The paper sheet is held at its front end with respect to the direction of rotation 11 by gripping means 10. The impression cylinder 6, referred to below simply as the printing cylinder 6, as is generally customary, has at least one such gripping means 10 and can successively hold on its outer surface 8 a number of printed sheets corresponding to the number of gripping means. The printing cylinder 6 of FIG. 1 has, for example, two gripping means 10 located diametrically opposite one another.

Each gripping means 10 contains a channel 12 (or gap) which interrupts the outer surface 8 and extends over the entire cylinder length and in which a gripper strip 14 (or a multiplicity of grippers) is pivotable about an axis of rotation 16, in order, with a gripper nose 18, to clamp the front edge of a printed sheet (not illustrated) next to the channel 12 onto the outer surface 8 and then release it again for passing the printed sheet on to a further processing station. The gripper nose 18 projects from the channel 12 beyond the rear end 20 of the channel 12, with respect to the direction of rotation 11. The channel has a circumferentially opposite front end 22.

During the printing operation described above, a cleaning unit 24 is spaced from the outer surface 8 in a parking position 24-1.

FIG. 1 does not show the printing operation described above. Instead, it shows the cleaning operation for cleaning the outer surface 8 of the printing cylinder 6. During that operation, the cleaning unit 24 contacts the outer surface 8 in a cleaning position. The cleaning operation is normally a washing operation, since the outer surface 8 of the printing cylinder 6 can be cleaned more quickly wet than dry. As a result of the rotation of the printing cylinder 2 in the direction of rotation 11, a cleaning element 26, for example a washing cloth, brushes against the outer surface 8. The washing cloth serving as the cleaning element 26 is in each case transported further on in steps when it does not contact the outer surface 8. The further transport of the washing cloth 26 takes place preferably by a device which transmits the movement of the cleaning unit 24 from the cleaning position, shown in FIG. 1, into the parking position 24-1 (or in the opposite direction of movement) to the washing cloth 26. Instead of a wet washing cloth 26, other cleaning elements may be used, for example, a dry cloth, or a wet or dry brush, or the like.

The cleaning element 26 is placed (pressed) resiliently and elastically against the outer surface 8. Consequently, that part of the cleaning unit 24 which carries the cleaning element 26 must be led somewhat nearer to the outer surface 8 than is necessary for weak contacting of the outer surface 8 by the cleaning element 26. To simplify the description, however, the operation is carried out below as though the cleaning unit 24, together with the cleaning element 26, were moved only exactly up to the outer surface 8.

The adjustment of the cleaning unit 24 between the cleaning position and the parking position 24-1 is carried out by at least one double-acting pneumatic actuator 28, having a pressure piston 30 which is connected mechanically to the cleaning unit 24. The actuator 28 has a throw-on pressure chamber 32 on one side of the pressure piston 30 and a throw-off pressure chamber 34 on the other side. They can alternately be acted upon by compressed air and vented by means of a valve arrangement 36.

The cleaning unit 24 is guided in a holding means 38 which is inserted into a printing machine frame (not shown) in which the cylinders 2,4 and 6 are mounted rotatably.

During the cleaning operation, in the present case the washing operation, care must be taken to ensure that the cleaning unit 24 does not penetrate into the channel 12 and then butt onto the rear end 20 of the latter, and that the cleaning element 26 does not butt onto the gripper nose 18 of the gripper strip 14, but is moved over and above them at a vertical distance (or, according to another embodiment, the gripper nose 18 contacts only with slight pressure), so that the cleaning element 26 and the gripper strip 14 do not catch on one another and damage one another. In the preferred embodiment described here, it is assumed that the cleaning unit 24, together with the cleaning element 26, is carried over the gripper nose 18 and over the entire width of the channel 12 in the direction of rotation 11 by means of a control-cam/cam-follower arrangement 40. According to another embodiment, there is also the possibility that the cleaning unit 24, together with the washing element 26, is not already lifted off from the front end 22 of the channel 12 or just in front of it over and above the radius of the outer surface 8, but only just in front of the gripper nose 18. This has the disadvantage, however, that the climb-out of the control cam must be made the steeper, the shorter the latter is, and that with an increase in cam steepness, the material wear and noises caused by the butting of the cam follower likewise increase.

Consequently, a control cam 42 fastened to the printing cylinder 6 near to each gripping means 10 has, in a circumferential direction of the cylinder, a length from cam start 44 to cam end 46 which raises the cleaning element 26 to a larger cylinder radius than the gripper nose 18 and then lowers it again. This distance is preferably approximately equal to or slightly greater than the distance from the front end 22 of the channel 12 to the end of the gripper nose 18 of the same channel 12, as seen opposite to the direction of rotation 11 of the cylinder. For clearer illustration, FIG. 1 shows only one control-cam element 41 for one of the two gripping means 10. In reality, such a control-cam element is fastened to the printing cylinder 6 for each gripping means 10. The control cam 42 has, as seen opposite to the direction of rotation 11 of the cylinder, a cam rise 52, rising only with low steepness from the cam start 44 to a crest tip 48 on a cam crest 50, and a cam fall 54 falling, preferably more steeply, from the crest tip 48 to the cam end 46. The smooth rise of the cam rise 52 commences at the cam start 44 or just after it. At the crest tip 48, the cleaning element 26 is above the gripper nose 18, and, after the rear channel end 20, the cleaning element 26 is again placed onto the following outer surface 8 of the printing cylinder 6. FIG. 1 shows the situation where the cam follower 56 has run off the control cam to an extent such that the washing element 26 is placed on the outer surface 8 again. The cam fall 54 may fall steeply toward the cam end 46.

The valve arrangement 36 is part of a control means 60 which also contains an electronic control part 62 and a rotary-angle encoder 64. The rotary-angle encoder 64 indicates rotary-angle positions of the printing cylinder 6 to the electronic control part 62 when the actuator 28 is acted upon by pneumatic pressure or is vented. Switches actuated by the printing cylinder 6, for example proximity switches, may be used as rotary-angle encoder 64. However, an incremental encoder is preferred.

The control means 60 is designed such that the throw-on pressure chamber 32 of the cleaning unit 24 is automatically vented for the cam rise 52, the commencement of venting being dependent on the rotary-angle position of the printing cylinder 6 in relation to the cleaning unit 24. Furthermore, the control means 60 is designed such that, after the venting mentioned, the pneumatic throw-on pressure of the cleaning unit 24 is built up automatically again for that portion of the outer surface 8 of the rotating printing cylinder 6 which follows the gripping means 10. The commencement of venting and/or the commencement of rebuild-up of the pneumatic throw-on pressure of the actuator 28 on the cleaning unit 24 is preferably variably adjustable.

In addition to the commencement of venting, preferably also the commencement of the rebuild-up of the pneumatic throw-on pressure is dependent on the rotary-angle position of the printing cylinder 6 in relation to the cleaning unit 24.

A preferred embodiment for this purpose is described below.

The valve arrangement 36 contains a positioning valve 66 and, downstream of the latter, a pressure control valve 68. By means of the valves, in the valve positions shown in FIG. 1, the pneumatic pressure of a compressed-air source 70 acts via a pressure regulator 72 in the throw-on compressor chamber 32 and thereby moves the cleaning unit 24 from the parking position 24-1 into the cleaning position 24 and there presses the cleaning element 26 onto the outer surface 8, in order to clean the latter while the printing cylinder 6 is rotating. The two valves 66 and 68 are preferably 5/2-way valves.

The pressure control valve 68 is located in the compressed-air path 74 from the positioning valve 66 to the throw-on pressure chamber 32 and subdivides said path into the two path portions 74-1 and 74-2. Furthermore, a compressed-air path 76, which bypasses the pressure control valve 68, is formed from the positioning valve 66 to the throw-off chamber 34 of the actuator 28. By the positioning valve 66 being changed over into its valve position not shown in FIG. 1 and with the valve position, shown in FIG. 1, of the pressure control valve 68 being maintained, the flow-on pressure chamber 32 is vented by the positioning valve 66, and the throw-off pressure chamber 34 is connected by the positioning valve 66 to the pressure source 70, so that the pneumatic pressure of the latter in the throw-off pressure chamber 34 moves the pressure piston 30 and consequently also the cleaning unit 34 from the position depicted by continuous lines back into the parking position 34-1.

An adjustable flow throttle 78 or 80 may be located in each case in the compressed-air path 76 of the throw-off chamber 34 and in the compressed-air path 74, preferably in the path portion 74-1 between the two valves 66 and 68, to which flow throttle is connected in parallel in each case a non-return valve 79 or 81 opening in the pressure direction of the compressed-air source 70. The pressure of the compressed-air source 70 can thereby in each case be built up quickly, unthrottled, in the chambers 32 and 34, and the venting of these chambers 32 and 34 can be set variably by means of the throttles 78 and 80.

When, during the cleaning operation shown in FIG. 1, the front edge 22 reaches the vicinity of the cleaning element 26 and therefore the cam follower 66 is also located at or just in front of the cam start 44, this is recognized by the electronic control part 62 by means of the rotary-angle encoder 64 and the electronic control part 62 switches over the pressure control valve 68 from the pressure build-up position shown in FIG. 1 into the valve position, not shown, in which the pressure control valve connects the throw-on chamber 32 of the actuator 28 to the outside atmosphere 82, preferably via an adjustable flow throttle 84. As a result of this venting, the control cam 42 can press the cleaning unit 24 radially beyond the radius of the outer surface 8, without the pneumatic pressure in the throw-on pressure chamber 32 being substantially increased by the cleaning unit 24 being pushed back in this way. On the contrary, as a result of venting, the pneumatic pressure can be kept constant or reduced. It is preferably reduced in this case.

This pressure reduction may also be accelerated by the additional changeover of the positioning valve 66 into the valve position, not shown in FIG. 1, in which compressed air of the compressed-air source 70 can pass via the positioning valve and the compressed-air path 76 into the throw-off chamber 34, so that the release of the cleaning unit 24 by the control cam 42 is accelerated.

The commencement of the above-described venting of the throw-on chamber 32 and of the counterpressure action in the throw-off pressure chamber 34 can take place exactly at the front channel end 22 or preferably just in front of it, or after it, but in front of the gripper nose 18. The further in front of the gripper nose 18 this takes place, the flatter (small pitch angle) the cam rise 52 can be. Preferably, the commencement of the pressure chamber 32 and/or the commencement of the action of pressure upon the throw-on pressure chamber 34 for the cam rise 52 is variably adjustable.

At the end of the control cam 42, the cleaning unit 24 must be placed with its cleaning element 26 again onto the then following portion of the outer surface 8, preferably with the pressure force necessary for cleaning the outer surface 8. Therefore, the throw-off chamber 34 is vented again by means of the valve position, shown in FIG. 1, of the positioning valve 66, and the throw-on pressure chamber 32 is acted upon again by compressed air from the compressed-air source 70 by means of the position, shown in FIG. 1, of the positioning valve 66 and of the pressure control valve 68, even before the cam follower 56 goes over from the control cam 42 onto the outer surface 8, that is to say preferably even before the cam end 46, for example still on the cam fall 54 or even in the vicinity of the cam tip 48, just in front of the latter (on the latter or after the latter). The exact time point and the exact angular position of the printing cylinder 6 for this operation are preferably variably adjustable.

During the introduction of compressed air into the throw-on pressure chamber 32 and the throw-off pressure chamber 34 and during the venting of these chambers, it is necessary to ensure that this aeration and venting last some time and should therefore be started before the consequently desired relative positions between the cleaning unit 24 and the rotary-angle position of the printing cylinder 6 are reached. The higher is the rotational speed of the printing cylinder 6, the earlier in time must the aerations and ventings described be started before the desired relative positions and pressures between the cleaning unit 24 and the respective rotary-angle position of the printing cylinder 6. This means that the exact time points and angular positions are dependent on several properties of the printing machine. In addition to the rotational speed of the printing cylinder 6, for example, they are also dependent on the type of gripping means 10 and its size in the circumferential direction of the cylinder and in the direction radially beyond the diameter of the outer surface 8.

The cam follower 56 may be formed or fastened rigidly on the washing means 24, for example in the vicinity of the cleaning element or via a carrier arm. However, the cam follower and such a carrier arm increase the weight of the cleaning unit 24 and impede the removal of the latter from and its insertion into the holding means 38 in the machine stand.

According to the preferred embodiment shown in FIG. 1, the cam follower 56 is provided at a first end 98 of a lever arrangement 86 which is mounted on the holding means 38 and which has a second end 100 bearing on supporting surface 104 of the cleaning unit 24. The supporting surface points toward the cylinder circumference of the printing cylinder 6. The two ends 98 and 100 can in each case be moved only jointly in the direction of the printing cylinder 6 or away from the latter, so that the cleaning unit 24 is moved in the direction away from the printing cylinder 6 by the cam rise 52 and can be moved in the direction toward the printing cylinder by the cam fall 54.

According to the preferred embodiment, the lever arrangement 86 is a toggle-lever arrangement which has two rocker levers 90 and 92, mounted on the holding means 38 in each case by means of a mounting 87 and 88, and an intermediate lever 94, the ends of which are rotatably mounted in each case at one end of the two rocker levers 90 and 92. Mountings 95 and 96 cause all the bearing axes to be arranged parallel to the axis of rotation of the printing cylinder 6.

The cam follower 56 is arranged at the first end 98 of the lever arrangement 86. The second end 100 of the lever arrangement has formed on it a stop 102 which bears on the supporting surface 104 of the cleaning unit 24 in the direction away from the printing cylinder 6, and the supporting surface points in the direction of the printing cylinder 6. The cam follower 56 and/or the stop 102 of the lever arrangement 86 may be elements which are immovable in relation to the levers, but, to avoid material wear and to avoid frictional resistances, each is formed preferably by a roller which is mounted in each case on the respective rocker lever 90 and 92 rotatably about an axis of rotation which is parallel to the axis of rotation of the printing cylinder 6.

Using two rocker levers 90 and 92 and the intermediate lever 94 connecting them to one another in an articulated manner, enables the two lever ends 98 and 100 in each to case be moved only jointly in the direction of the control cam 42 or toward the printing cylinder 6 or away from the latter.

A tension spring 106 is fastened with prestress, on the one hand, to the holding means 38 and, on the other hand, to one of the two lever arms, projecting away from one another, of the rocker levers 90, 92, preferably to that lever arm of the second rocker lever 92 which acts on the cleaning unit 24. As a result, during the removal and insertion of the cleaning unit 24 out of and into the holding means 38, the tension spring 106 remains on this holding means, together with the toggle-lever arrangement 86. Consequently, the weight of the cleaning unit 24 is not increased by the tension spring 106, and the latter does not disturb the handling of said cleaning unit 24 during the removal and insertion of the latter out of and into the holding means 38.

The tension spring 106 pulls the cleaning unit 24 away from the printing cylinder 6 via the toggle-lever arrangement 86 when the pneumatic pressure fails in the actuator 28. It therefore has a safety function, by virtue of which damage to the washing means 24 and/or the gripping means 10 due to mutual contacting in the event of a failure of the pneumatics is prevented. The force acting on the cleaning unit 24 by the tension spring 106 is lower than the force normally generated on the cleaning unit 24 by the pneumatic pressure. The tension spring 106, like the action of compressed air on the throw-off pressure chamber 34 of the actuator 28 during the venting of the throw-on pressure chamber 32 before and/or during the run of the cam follower 56 onto the cam rise 52, has the advantage that the pressure acting on the control cam 42 by the cleaning unit 24 can consequently be reduced more quickly.

Instead of a tension spring 106, a compression spring may also be used between the lever arrangement and the holding means 38, the force of said compression spring acting on the cleaning unit 24 in the same direction. The arrangement of at least one control cam 42, of a cam follower 56, of a toggle-lever arrangement 86 and of a spring 106 (tension or compression spring) may be provided on one end face or on both end faces of the printing cylinder 6.

According to another embodiment of the invention, the compressed-air path 74 of the throw-on pressure chamber 32 or the throw-on pressure chamber 32 itself may be provided with a pressure relief valve 110 or with another pressure-limiting element which limits the pneumatic pressure in it, in addition to or instead of the pressure control valve 68.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A printing machine cylinder cleaning device of a sheet-fed printing machine, containing a cleaning unit for cleaning the outer surface of a printing machine cylinder, a throw-on device, at least one pneumatic actuator with a throw-on pressure chamber for the pneumatic throwing and pressing of the cleaning unit onto the cylinder outer surface of the printing machine cylinder to be cleaned, while there is no printed sheet located on the latter, a control-cam/cam-follower arrangement with at least one control cam and with at least one cam follower, running on the latter, for supporting the cleaning unit, instead of by the cylinder outer surface, and at the same time for guiding the cleaning unit over and above at least one printed-sheet gripping means, provided on the printing machine cylinder, as a function of the rotary-angle position of a printing machine cylinder in relation to the cleaning unit, whenever the gripping means of the rotating printing machine cylinder rotates past the cleaning unit, wherein a control means is provided, which is designed for the automatic venting of the throw-on pressure chamber of the actuator for a cam rise of a control cam of the control-cam/cam-follower arrangement, the commencement of venting being dependent on the rotary-angle position of the printing machine cylinder in relation to the cleaning unit, and wherein the control means is designed for an automatic rebuild-up of the pneumatic throw-on pressure in the throw-on pressure chamber of the actuator for that portion of the cylinder outer surface of the rotating printing machine cylinder which follows the gripping means.

2. The printing machine cylinder cleaning device as claimed in claim 1, wherein the commencement of the venting of the pneumatic throw-on pressure of the throw-on pressure chamber is adjustable with respect to the rotary-angle position of the printing machine cylinder in relation to the cleaning unit.

3. The printing machine cylinder cleaning device as claimed in claim 1, wherein the commencement of the rebuild-up of the pneumatic throw-on pressure in the vented throw-on pressure chamber is adjustable.

4. The printing machine cylinder cleaning device as claimed in claim 3, wherein the commencement of the rebuild-up of the pneumatic throw-on pressure is adjustable with respect to the rotary-angle position of the printing machine cylinder in relation to the cleaning unit.

5. The printing machine cylinder cleaning device as claimed in claim 1, wherein the control means is designed in such a way that the rebuild-up of the pneumatic pressure in the throw-on pressure chamber recommences even while the cleaning unit is still thrown onto the control-cam/cam-follower arrangement instead of onto the cylinder outer surface.

6. The printing machine cylinder cleaning device as claimed in claim 1, wherein the at least one actuator has a throw-off pressure chamber for generating a pneumatic pressure which acts in the opposite direction to the pressure capable of being generated pneumatically in the throw-on pressure chamber.

7. The printing machine cylinder cleaning device as claimed in claim 6, wherein the venting of the pneumatic pressure in the throw-on pressure chamber can be accelerated by a pneumatic pressure being generated in the throw-off pressure chamber, in order thereby to drive the compressed air out of the throw-on pressure chamber while the throw-on pressure chamber is switched by the control means to venting, in order to reduce the pressure force of the cleaning unit on the cam rise of the control-cam/cam-follower arrangement.

8. The printing machine cylinder cleaning device as claimed claim 1, wherein the rebuild-up of the pneumatic pressure in the throw-on pressure chamber of the actuator takes place in the region between an end portion of a cam rise in front of a cam crest tip and the cam end.

9. The printing machine cylinder cleaning device as claimed in claim 1, wherein the commencement of the venting of the throw-on pressure chamber begins before the control-cam/cam follower arrangement takes over the throw-on pressure of the cleaning unit from the cylinder outer surface.

10. The printing machine cylinder cleaning device as claimed in claim 1, wherein the control-cam/cam-follower arrangement has a cam rise, of which the length in the circumferential direction of the printing machine cylinder is approximately equal to the circumferential distance of the cylinder from a front channel end of a gripper channel to the radially highest point of a printed-sheet gripper projecting from the gripper channel of the rear channel end.

11. The printing machine cylinder cleaning device as claimed in claim 1, wherein a control cam, which in each case cooperates with a cam follower of the cleaning unit, is arranged on the printing machine cylinder for each gripping means provided on the latter.

12. The printing machine cylinder cleaning device as claimed in claim 11, wherein the control cam is arranged, in a circumferential direction of the printing machine cylinder, at least partially in front of or after the gripping means belonging to it, and wherein the cam follower is provided at a first end of a lever arrangement which is mounted rotatably on a holding means receiving the cleaning unit and which has a second end which bears on a supporting surface of the cleaning unit, said supporting surface pointing toward the cylinder circumference of the printing machine cylinder, the two ends being in each case movable only jointly in the direction of the printing machine cylinder or away from the latter.

13. The printing machine cylinder cleaning device as claimed in claim 12, wherein the lever arrangement is a toggle-lever arrangement which contains two rocker levers mounted rotatably on the holding means by means of rotary bearings, and an intermediate lever, the ends of which are in each case mounted rotatably at an adjacent end of the rocker levers in each case by means of a rotary bearing, all bearing axes being arranged parallel to the axis of rotation of the printing machine cylinder, and wherein those ends of the rocker levers which are remote from the intermediate lever form the two ends of the toggle-lever arrangement.

14. The printing machine cylinder cleaning device as claimed in claim 1, wherein at least one spring is provided, the spring force of which acts on the cleaning unit in the opposite direction to the pneumatic pressure in the throw-on pressure chamber on the cleaning unit and exerts on the latter a lower force than the pneumatic pressure in the throw-on pressure chamber during the throwing of the cleaning unit onto the cylinder outer surface or onto the control-cam/cam-follower arrangement.

15. The printing machine cylinder cleaning device as claimed in claim 14, wherein the at least one spring engages, on the one hand, on the holding means and, on the other hand, on the lever arrangement.
